(19) United States
(12) Patent Application Publication
(10) Pub. No.: US 2025/0260776 A1
(43) Pub. Date: Aug. 14, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: HIROYASU KUNIEDA, Kanagawa (JP); AKITOSHI YAMADA, Kanagawa (JP); YOICHI KASHIBUCHI, Kanagawa (JP)

(21) Appl. No.: 19/052,202

(22) Filed: Feb. 12, 2025

(30) Foreign Application Priority Data
Feb. 13, 2024 (JP) 2024-019858

(51) Int. Cl. H04N 1/32; G06K 15/12

(52) U.S. Cl. CPC H04N 1/32208; G06K 15/129

(57) ABSTRACT

An image processing apparatus includes a print data acquisition unit configured to acquire print data to be printed on a printing medium, and a generation unit configured to generate multiplexed data by multiplexing a first predetermined pattern with a printing area where the print data is printed among areas of the printing medium and multiplexing a second predetermined pattern with a marker area different from the printing area among the areas of the printing medium, wherein the multiplexed second predetermined pattern has a density lower than that of the multiplexed first predetermined pattern on the printing medium.

### BACKGROUND

### Field of the Disclosure

The present disclosure relates to processing for multiplexing information on a document.

### Description of the Related Art

In recent years, techniques for using and storing electronic documents as originals instead of paper documents have been implemented. As a result, cases are arising where, with electronic documents as originals, those printed on paper are treated as duplicates thereof.

Methods for embedding management information into printed documents are thus used to determine the authenticity of documents printed on paper. Documents are printed on sheets of paper using various printing methods including electrophotographic printing and inkjet printing. Japanese Patent Application Laid-Open No. 2001-148778 discusses embedding inconspicuous information in printouts by inkjet printing.

However, the technique discussed in Japanese Patent Application Laid-Open No. 2001-148778 does not assume cases where the added information can be extracted if the area where the information section is embedded is identified in the duplicated multiplexed documents.

### SUMMARY

According to embodiments of the present disclosure, an image processing apparatus includes a print data acquisition unit configured to acquire print data to be printed on a printing medium, and a generation unit configured to generate multiplexed data by multiplexing a first predetermined pattern with a printing area where the print data is printed among areas of the printing medium and multiplexing a second predetermined pattern with a marker area different from the printing area among the areas of the printing medium, wherein the multiplexed second predetermined pattern has a density lower than that of the multiplexed first predetermined pattern on the printing medium.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a printing system.

FIGS. 2A and 2B are flowcharts of authentic document identifier (ID) information embedding processing and extraction processing.

FIG. 3 is a diagram illustrating an example of document data.

FIGS. 4A, 4B, and 4M are diagrams illustrating masks for producing image variations.

FIGS. 5A, 5B, and 5M are diagrams visually illustrating patterns.

FIGS. 6A and 6B are diagrams illustrating masks for producing image variations.

FIGS. 7A and 7B are diagrams visually illustrating patterns.

FIG. 8 is a flowchart of tampering determination processing.

FIGS. 9A to 9D are diagrams illustrating modifications of a first exemplary embodiment.

FIG. 10 is a diagram illustrating the spatial frequency characteristics of patterns used for embedding.

FIG. 11 is a flowchart of processing for changing an embedding strength (multiplexing strength) depending on a printing method.

FIG. 12 is a flowchart of processing for changing an image color plane to be multiplexed depending on the printing method.

FIGS. 13A to 13D are diagrams illustrating strength-specific embedding masks to be used during multiplexing.

FIGS. 14A, 14B, and 14M are diagrams illustrating masks for producing image variations.

FIGS. 15A, 15B, and 15M are diagrams visually illustrating patterns.

FIG. 16 is a diagram for describing an area to superpose document ID information on.

FIGS. 17A and 17B are schematic diagrams illustrating inkjet and electrophotographic multifunction printers (MFPs).

FIG. 18 is a flowchart of information embedding processing.

FIGS. 19A, 19B, and 19M are diagrams illustrating masks for producing image variations.

FIGS. 20A, 20B, and 20M are diagrams visually illustrating patterns.

### DESCRIPTION OF THE EMBODIMENTS

Exemplary embodiments will be described with reference to the drawings. The exemplary embodiments are not intended to limit the disclosure, and all combinations of features described in the exemplary embodiments are not necessarily essential to the solving means of the present disclosure. Similar components will be described with the same reference numerals, and redundant descriptions will be omitted. Image data expressing an image may hereinafter be referred to simply as an image.

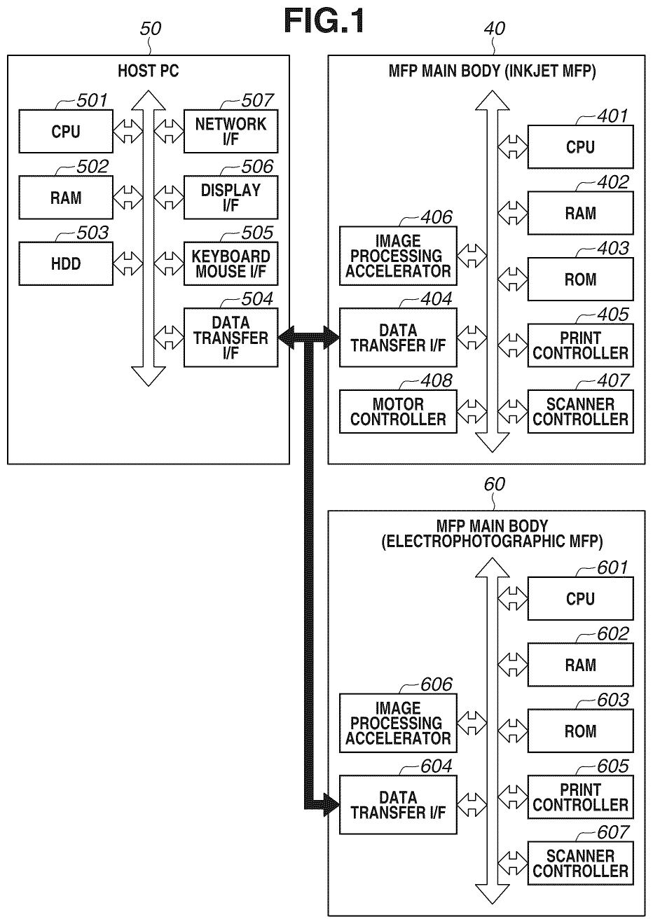

A first exemplary embodiment will be described. FIG. 1 is a block diagram illustrating a configuration of a printing system that prints multiplexed documents. This printing system includes a multifunction printer (MFP) apparatus (hereinafter, may be referred to as an MFP main body) 40 using an inkjet printing method, an MFP apparatus (MFP main body) 60 using an electrophotographic printing method, and a personal computer (PC) 50 serving as a host apparatus (hereinafter, may be referred to as a host PC). As employed herein, an MFP main body refers to a printer having a plurality of functions such as a printer function and a scanner function, and sometimes with a copy function that is implemented by the cooperation of the plurality of functions.

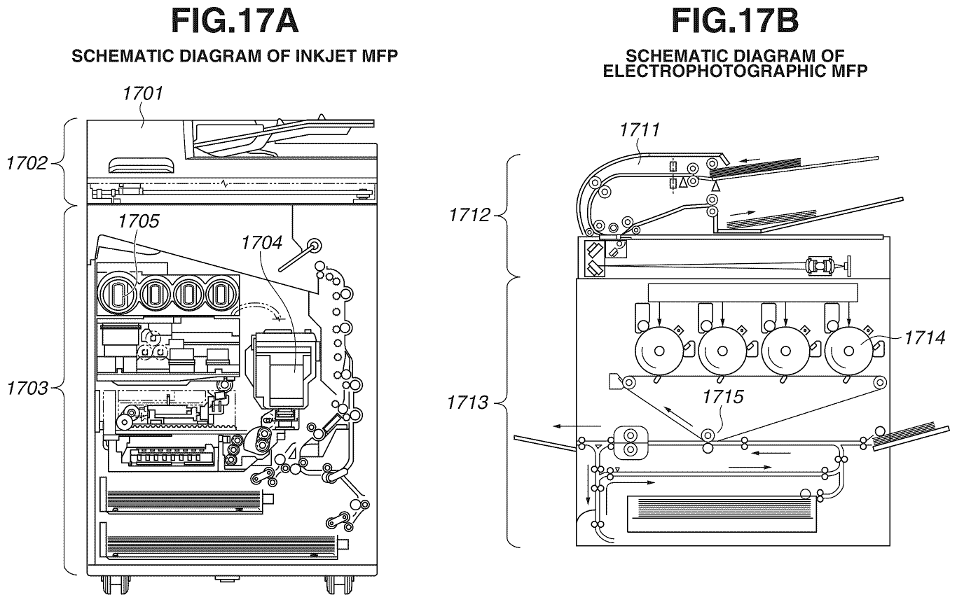

FIGS. 17A and 17B are schematic diagrams illustrating MFPs. FIG. 17A is a schematic diagram illustrating an inkjet MFP 1701. FIG. 17B is a schematic diagram illustrating an electrophotographic MFP 1711. The inkjet MFP 1701 includes a scanner unit 1702 and a print unit 1703. The print unit 1703 includes a recording head 1704 and an ink tank unit 1705. The recording head 1704 discharges inks based on print data. The ink tank unit 1705 stores the inks to be supplied to the recording head 1704. The stored inks (colorants) are cyan, magenta, yellow, and black inks. Depending on the model, special color inks are additionally stored.

The electrophotographic MFP 1711 includes a scanner unit 1712 and a print unit 1713. The print unit 1713 includes photoelectric drums 1714 and a transfer roller 1715. There are as many photoelectric drums 1714 as the colorants, respectively corresponding to cyan, magenta, yellow, and black toners. Latent images are formed on the photoelectric drums 1714 based on print data. The transfer roller 1715 transfers toner images obtained by developing the formed latent images to a sheet that is a conveyed printing medium, whereby print processing is performed.

The host PC 50 mainly includes the following components. A central processing unit (CPU) 501 performs processing based on programs stored in a hard disk drive (HDD) 503 and a random access memory (RAM) 502. The RAM 502 is a volatile storage and temporarily stores programs and data. The HDD 503 is a nonvolatile storage and also stores programs and data. A data transfer interface (I/F) 504 controls data transmission and reception to/from the MFP main body 40 and the MFP main body 60. Wired connections such as Universal Serial Bus (USB), the Institute of Electrical and Electronics Engineers (IEEE) 1394, and a local area network (LAN) or wireless connections such as Bluetooth® and Wireless Fidelity (Wi-Fi) can be used as a connection method for the data transmission and reception. If a printer model is set using a driver during printing, print data is transmitted to the specified MFP via the data transfer I/F 504. A keyboard mouse I/F 505 is an I/F for controlling human interface devices (HIDs) such as a keyboard and a mouse. The user can input via the keyboard mouse I/F 505. A display I/F 506 controls display on a display device (not illustrated). A network I/F 507 connects the host PC 50 to an external network, communicates with one or more external PCs, and issues document identifier (ID) collation requests, result requests, and document data requests.

The MFP main body 40 using the inkjet printing method mainly includes the following components. A CPU 401 performs processing based on programs stored in a read-only memory (ROM) 403 and a RAM 402. The RAM 402 is a volatile storage and temporarily stores programs and data. The ROM 403 is a nonvolatile storage and can store table data for use in processing and programs. A data transfer I/F 404 controls data transmission and reception to/from the PC 50. A print controller 405 can be configured to read control parameters and recording data from predetermined addresses of the RAM 402. The print controller 405 performs print processing by controlling the heating operation of a print head (recording head) to discharge ink based on the control parameters and the recording data. An image processing accelerator 406 is a hardware component, and performs image processing at speed higher than the CPU 401. Specifically, the image processing accelerator 406 can be configured to read parameters and data for use in image processing from a predetermined address of the RAM 402. When the CPU 401 writes the parameters and data to the foregoing predetermined address of the RAM 402, the image processing accelerator 406 is activated to perform predetermined image processing.

It will be understood that the image processing accelerator 406 is not necessarily an essential element, and the processing for generating the foregoing parameters (table parameters) and the image processing may be performed by the CPU 401 alone depending on the printer specifications. A scanner controller 407 instructs a not-illustrated scanner unit to irradiate a document with light and transmit light amount information obtained by an image sensor, such as a charge-coupled device (CCD) sensor, capturing reflected light to the scanner controller 407.

Specifically, when the CPU 401 writes the control parameters and a read data write address to the foregoing predetermined address of the RAM 402, the scanner controller 407 starts processing. The scanner controller 407 controls light emission of light-emitting diodes (LEDs) mounted on the scanner unit, acquires light amount information from the scanner unit, and writes the light amount information at the read data write address and subsequent addresses of the RAM 402. A motor controller 408 controls motor operation of a not-illustrated plurality of motor units. The motor units are used to move the foregoing print head relative to a recording sheet and move the scanner unit relative to a document to be read. Some MFPs can include motors for doing maintenance on the recording head.

The MFP main body 60 using the electrophotographic printing method has a configuration similar to that of the inkjet MFP main body 40, and differs in the printing device section. A print controller 605 performs print processing through development and transfer of the drum surfaces based on the control parameters from the predetermined address of the RAM 602 and print data.

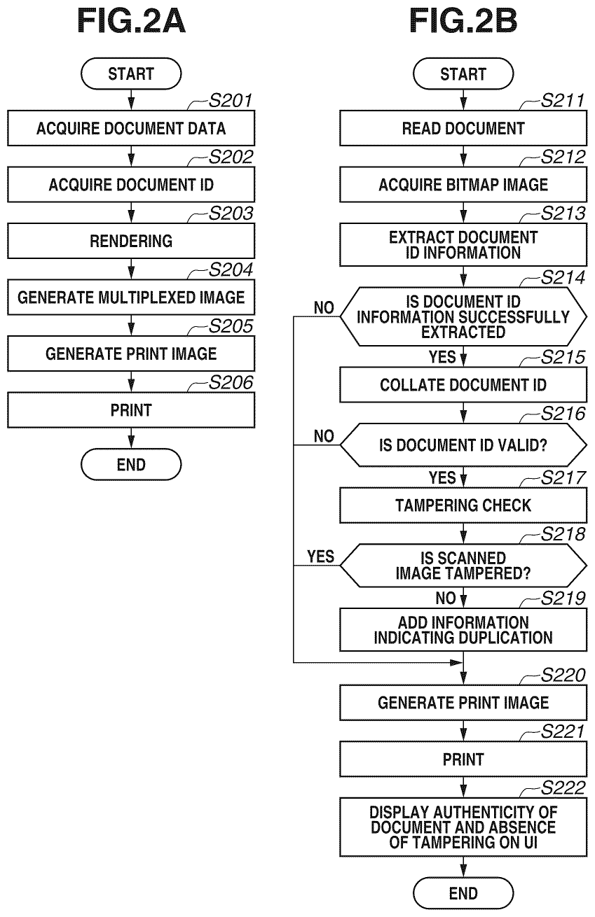

FIGS. 2A and 2B are flowcharts for describing authentic document ID information embedding processing and extraction processing according to the first exemplary embodiment. The steps of the flowchart are denoted by reference numerals starting with S. In FIG. 2A, steps S201 to S205 correspond to the authentic document ID information embedding processing. In FIG. 2B, steps S211 to S221 correspond to the authentic document ID information extraction processing.

The authentic document ID information embedding processing will now be described. The processing by inkjet recording will initially be described.

In step S201, the host PC 50 acquired document data. Specifically, in the present exemplary embodiment, the host PC 50 connects to an external PC via the network I/F 507, and requests and acquires document data.

Suppose that the document data is written in a page description language (PDL). The PDL includes a set of drawing commands page by page. Types of drawing commands are defined by the respective PDL specifications. In the present exemplary embodiment, the following three types are mainly used as an example:
Command 1) text drawing command (X1, Y1, color, font information, character string information);
Command 2) box drawing command (X1, Y1, X2, Y2, color, fill shape); and
Command 3) image drawing command (X1, Y1, X2, Y2, image file information).

Other drawing commands are also used as appropriate depending on the use purposes. Examples include a dot drawing command for drawing a dot, a line drawing command for drawing a line, and a circle drawing command for drawing an arc.

Examples of PDLs that are commonly used include Portable Document Format (PDF) proposed by Adobe Inc., Extensible Markup Language (XML) Paper Specification (XPS) proposed by Microsoft Corporation, and Hewlett-Packard Graphics Language 2 (HP-GL/2) proposed by the Hewlett-Packard Company. However, the range of application of the present exemplary embodiment is not limited thereto.

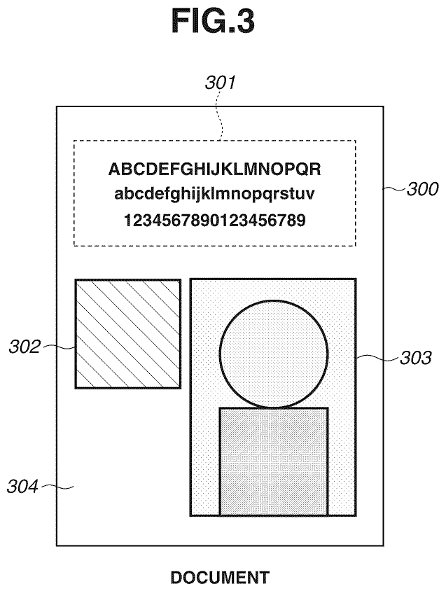

FIG. 3 illustrates an example of document data. A document 300 represents one page of document data, with a horizontal width of 600 pixels and a vertical width of 900 pixels.

The following is an example of PDL corresponding to the document data of FIG. 3:

<PAGE=001>
<TEXT> 50,50, 550, 100, BLACK, STD-18, “ABCDEFGHIJKLMNOPQR” </TEXT>
<TEXT> 50,100, 550, 150, BLACK, STD-18, “abcdefghijklmnopqrstuv” </TEXT>
<TEXT> 50,150, 550, 200, BLACK, STD-18, “1234567890123456789” </TEXT>
<BOX> 50, 300, 200, 450, GRAY, STRIPE </BOX>
<IMAGE> 250, 300, 550, 850, “PORTRAIT.jpg” </IMAGE>
</PAGE>

The tag <PAGE=001> in the first line indicates the number of pages in the present exemplary embodiment. PDL is typically designed to be able to describe a plurality of pages, and tags indicating page breaks are included therein. In the present exemplary embodiment, the code up to </PAGE> in the ninth line represents the first page, which corresponds to the document 300 in FIG. 3. If there is a second page, the foregoing PDL code is followed by <PAGE=002>.

The code from <TEXT> in the second line to </TEXT> in the third line is drawing command 1, which corresponds to the first line in a text section 301. The first two coordinates indicate the coordinates (X1, Y1) at the top left of the drawing area, and the next two coordinates indicate the coordinates (X2, Y2) at the bottom right of the drawing area. The subsequent code indicates that the color is BLACK (black: red (R)=0, green (G)=0, and blue (B)=0), the text font is “STD” (standard), the text size is 18 points, and the character string to be written is “ABCDEFGHIJKLMNOPQR”.

The code from <TEXT> in the fourth line to </TEXT> in the fifth line is drawing command 2, which corresponds to the second line in the text section 301. Like drawing command 1, the first four coordinates and two character strings describe the drawing area, text color, and text font. The character string to be written is described to be “abcdefghijklmnopqrstuv”.

The code from <TEXT> in the sixth line to </TEXT> in the seventh line is drawing command 3, which corresponds to the third line in the text section 301. Like drawing commands 1 and 2, the first four coordinates and two character strings describe the drawing area, text color, and text font. The character string to be written is described to be “1234567890123456789”.

The code from <BOX> to </BOX> in the eighth line is drawing command 4, which corresponds to a rectangle drawing section 302. The first two coordinates indicate the top left coordinates (X1, Y1) of the drawing start point. The next two coordinates indicate the bottom right coordinates (X2, Y2) of the drawing end point. The color is GRAY (gray: R=128, G=128, and B=128). For the fill shape, STRIPE (stripe) representing a stripe pattern is specified. In the present exemplary embodiment, the stripe pattern always includes diagonal lines toward the bottom right. However, the BOX command may be configured so that the line angle and cycles can be specified.

The IMAGE command in the ninth line corresponds to an image section 303. Here, the filename of the image to be included in this section is described to be “PORTRAIT.jpg”, which indicates that this file is a Joint Photographic Experts Group (JPEG) file, a commonly used image compression format.

The tag </PAGE> in the tenth line indicates the end of drawing of this page.

The actual PDL file often integrally includes the “STD” font data and “PORTRAIT.jpg” image file. The reason is that if the font data and the image file are separately managed, the text and image sections are unable to be formed with the drawing commands alone and the information is insufficient to form the image of FIG. 3.

The above is the description of the document data acquired in step S201 of FIG. 2A.

In step S202, the host PC 50 acquires a document ID (hereinafter, may be referred to as document ID information) that indicates the authenticity of the document data acquired in step S201. The document ID is information calculated from all the document files including the foregoing PDL file, font data, and image file. In the present exemplary embodiment, the document ID is 128-bit information. The method for calculating the document ID information is designed so that a different document ID is calculated if any of the files constituting the document is modified. The document ID thus corresponds uniquely to the document files. Specifically, in the present exemplary embodiment, the host PC 50 requests the document ID from the external PC from which the document files are acquired in step S202, and receives the document ID.

Alternatively, a blockchain-like configuration can be employed so that a plurality of external PCs manages document data and document IDs, and the host PC 50 requests the document ID from the plurality of PCs. This can reduce the risk of tampering with the document ID itself.

In step S203, the host PC 50 renders the document data acquired in step S201. In this step, the host PC 50 executes the drawing commands described in the PDL to form a bitmap image including pixel-by-pixel color information.

In the present exemplary embodiment, as described above, the document 300 of FIG. 3 has a horizontal width of 600 pixels and a vertical width of 900 pixels. The bitmap image generated in this step therefore includes 600×900 pixels. Each pixel has 256 gradation levels, with 8 bits each for R, G, and B.

In step S204, the host PC 50 generates a multiplexed image.

More specifically, the host PC 50 superposes the document ID information acquired in step S202 on the rendered image generated in step S203. The purpose is so that a copying machine, when copying an output product on which the superposed image is printed, can extract the document ID from the scanned document and determine whether the output product is based on the digital document managed by the document ID.

Handling information with an information processing apparatus such as a PC means handling binary data.

Binary data is information consisting of 0's and 1's. A sequence of information consisting of 0's and 1's takes on a specific meaning. For example, if information “hello” is handled as binary data using “Shift Japanese Industrial Standards (JIS)”, which is one of character codes, “h” corresponds to binary data “01101000”. Similarly, “e” corresponds to binary data “01100101”, “1” to “01101100”, and “o” to “01101111”. In other words, the character string “hello” can be expressed by binary data “0110100001100101011011000110110001101111”. Conversely, if the binary data “0110100001100101011011000110110001101111” is acquired, the character string “hello” can be obtained. Based on this idea, it can be seen that multiplexing can be achieved by embedding data so that 0's and 1's can be determined.

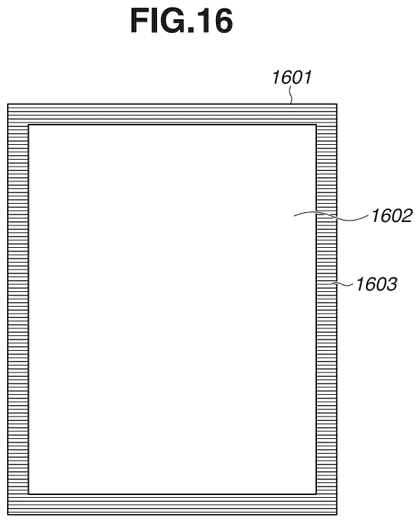

FIG. 16 is a diagram for describing which area of the bitmap image to superpose the document ID information on. To extract the embedded data from the multiplexed document, the area where the document ID information is embedded is identified using markers. For that purpose, the area to embed the document ID information in and a marker area for identifying the area are set on the bitmap image in printing the document, and multiplexing processing is performed on each area. An entire bitmap image 1601 to be multiplexed includes an information section 1602 that is the area to embed the document ID information in within the printing area, and a marker section 1603 that is the area to embed markers in the document.

For the sake of description, unlike the information section 1602, the marker section 1603 is set to surround the information section 1602, and the multiplexing is performed on the entire surface of the document. The marker section 1603 may be set on only some end portions of the information section 1602. Examples include the top end and the left end of the information section 1602. A part of the information section 1602, such as a top right portion, may be used as the marker section 1603. The marker section 1603 does not need to include the very ends, and may be located inside the very ends.

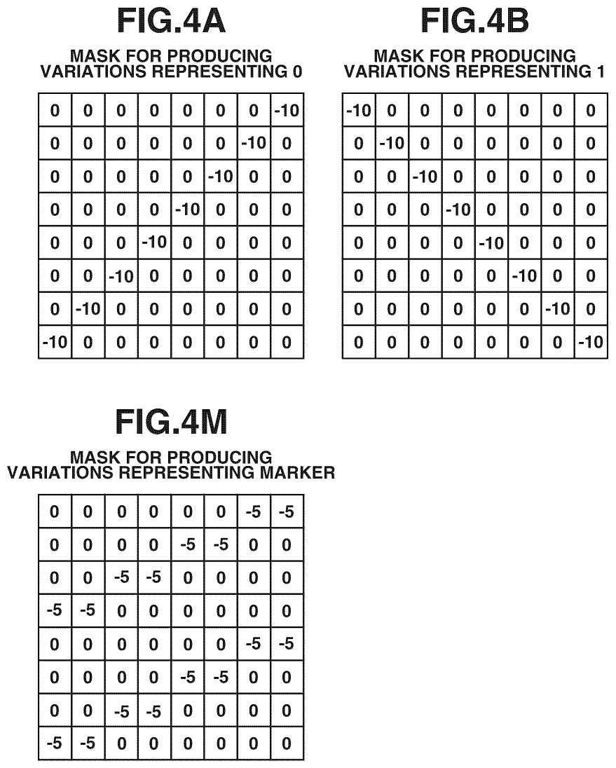

FIGS. 4A and 4B illustrate two masks (first predetermined patterns) for superposing “0” and “1” on the image. FIG. 4M illustrates a mask (second predetermined pattern) for superposing markers.

The masks of FIGS. 4A and 4B are used to embed information, and the mask of FIG. 4M is used to embed markers for identifying the position of the information section 1602 during extraction. The mask of FIG. 4M intended for markers is configured to have a density thinner (lower) than that of the masks of FIGS. 4A and 4B intended for the information section 1602.

Each mask consists of 8 pixels×8 pixels. A periodic pattern can be formed in 8×8-pixel areas in the image by adding the content of the mask to the image, i.e., changing the density of the print data. Digital images are basically expressed in 8 bits per color, with one of values from 0 to 255 assigned. Values outside this range are unable to be used as image data. If the calculation of a pixel value is less than 0 or greater than or equal to 256, 0 or 255 is therefore typically assigned to keep the pixel value within the effective range. The masks of FIGS. 4A and 4B produce variations of −10 or 0 in the pixel values. If the pieces of image data in a masked area are all 0, the resulting values in the area are all 0, not −10 and 0. The same applies to the mask of FIG. 4M. While the present exemplary embodiment deals with the bit depth of 8 bits per color, the bit depth may of course be other than 8 bits. In handling digital images, there always exists an effective range no matter how many bits are used for representation, and variations beyond the range are unable to be applied.

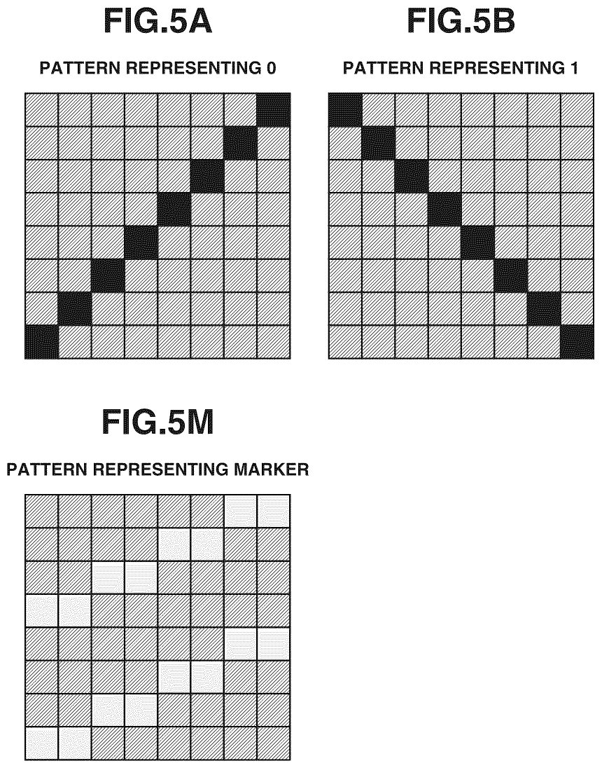

FIGS. 5A, 5B, and 5M visually illustrate what patterns are applied to the image by the masks of FIGS. 4A, 4B, and 4M. The positions where the masks of FIGS. 4A and 4B are “−10” are illustrated in black, and the positions where the masks are “0” are hatched. As a result, diagonal lines appear in the image as illustrated in FIGS. 5A and 5B. The positions where the mask of FIG. 4M is “−5” are illustrated in gray, and the positions where the mask is “0” are hatched. As a result, diagonal lines appear in the image as illustrated in FIG. 5M. For the sake of description, the mask of FIG. 4M shall include two diagonal lines of which the density is set to one half that of the diagonal lines in the masks of FIGS. 4A and 4B. This can bring the recording densities of the information section 1602 and the marker section 1603 close to each other. The settings of the area densities may be changed depending on a medium type that is the type of the printing medium to be printed, a print mode, and the density and amount of information of the bitmap image. The numbers of diagonal lines are adjusted accordingly to bring the printing densities of the information section 1602 and the marker section 1603 close to each other. Compared to the information section 1602, the marker section 1603 tends to have a low pattern density but with more pixels modulated. Values set in advance using such an adjustment method may be stored. The values may be set depending on the device characteristics. In the foregoing description, the diagonal lines in the mask of FIG. 4M are described to have a density one half that in the information-embedding masks of FIGS. 4A and 4B. However, the density may be less than or equal to one half. In such a case, the recording densities of the information section 1602 and the marker section 1603 can be brought close to each other by increasing the number of diagonal lines.

The marker section 1603 has a width as much as two mask blocks (16 pixels), and the marker masks are embedded in the area. For the information section 1602, the masks of FIGS. 4A and 4B are switched based on the binary values of the document ID information and embedded in the set area of the information section 1602. The following pseudocode shows how to switch the patterns in the information section 1602 and the marker section 1603:

| | |
|---|---|
| 01: | int i, j, k, l; |
| 02: | int width = 600, height = 900; |
| 03: | unsigned char *data = image data; |
| 04: | int** Mask0 = mask data (Fig. 4A); |
| 05: | int** Mask1 = mask data (Fig. 4B); |
| 06: | int** Marker = mask data (Fig. 4M); |
| 07: | int** switchingMask = mask switching data (Fig. 16); |
| 08: | for(j = 0; j < height; j += 8){ |
| 09: | for(i = 0; i < width; i += 8){ |
| 10: | for(k = 0; k < 8; k++){ |
| 11: | for(l = 0; l < 8; l++){ |
| 12: | if(switchingMask[(i + k) + (j + l) * width] == 0){ |
| 13: | data[(i + k) + (j + l) * width] += Mask0[k][l]; |
| 14: | } |
| 15: | else if(switchingMask[(i + k) + (j + l) * width] == 1){ |
| 16: | data[(i + k) + (j + l) * width] += Mask1[k][l]; |
| 17: | } |
| 18: | else if(switchingMask[(i + k) + (j + l) * width] == −1){ |
| 19: | data[(i + k) + (j + l) * width] += Marker[k][l]; |
| 20: | } |
| 21: | } |
| 22: | } |
| 23: | } |
| 24: | } |

The processing of the program will be described.

In line 02, the host PC 50 sets the width and height of the bitmap image to be multiplexed in terms of the numbers of pixels. In line 03, the host PC 50 sets the starting address in loading the bitmap image to be multiplexed into a memory area.

In line 04, the host PC 50 sets the starting address of the memory area where the mask representing binary data “0” is stored. Similarly, in line 05, the host PC 50 sets the starting address of the memory area where the mask representing binary data “1” is stored. In line 06, the host PC 50 sets the starting address of the memory area where the mask representing the marker is stored.

In line 07, the host PC 50 sets data describing the switching of the masks to be used (mask switching data). The mask switching data specifies the masks to be used pixel by pixel based on the information section 1602 and the marker section 1603 specified in FIG. 16. The mask switching data on the pixels to embed binary data “0” in within the information section 1602 is set to “0”. The mask switching data on the pixels to embed binary data “1” in is set to “1”. As for the marker section 1603, the mask switching data is set to “−1”. The starting address of the memory area where the mask switching data including such settings is loaded is set in line 07.

In lines 08 and 09, the host PC 50 sets the loops for the coordinate positions to successively process the bitmap image. The reason why the coordinate positions are incremented in units of eight pixels is to skip processing as much as the size of the masks in use.

In lines 10 and 11, the host PC 50 processes the bitmap image in units of pixels based on the mask size. In lines 12, 15, and 18, the host PC 50 calculates processing coordinates based on i, j, k, and l, refers to the mask switching data at the coordinates, and determines whether the mask switching data matches the conditions. If the mask switching data referred to is “0”, the processing proceeds to line 13. In line 13, the host PC 50 acquires the variation value of the mask of FIG. 4A based on k and l, and overwrites the pixel value of the bitmap image at the target coordinates with the sum of the acquired variation value and the pixel value. If the mask switching data is not “0”, the processing proceeds to line 15.

In line 15, if the mask switching data referred to is “1”, the processing proceeds to line 16. In line 16, the host PC 50 acquires the variation value of the mask of FIG. 4B based on k and l, and overwrites the pixel value of the bitmap image at the target coordinates with the sum of the acquired variation value and the pixel value. If the mask switching data referred to is not “1”, the processing proceeds to line 18.

In line 18, if the mask switching data referred to is “−1”, the processing proceeds to line 19. In line 19, the host PC 50 acquires the variation value of the marker mask of FIG. 4M based on k and l, and overwrites the pixel value of the bitmap image at the target coordinates with the sum of the acquired variation value and the pixel value.

This series of processes is performed until the loops for i and j are completed.

The pattern densities of the information section 1602 and the marker section 1603 can thus be changed by switching the patterns to be embedded between the information section 1602 and the marker section 1603. The pattern of the marker section 1603 can be made thinner than those of the information section 1602 by making the modulation amount of the mask in the marker section 1603 smaller than that of the masks in the information section 1602.

In the present exemplary embodiment, such embedding is performed only on B pixel values among the RGB pixel values in FIG. 3. The reason is that if the image is recorded on a paper white section 304 using inks, yellow (Y) ink has low visibility compared to the other inks such as cyan (C) ink, magenta (M) ink, and black (K) ink. The embedded information is desirably as invisible as possible so that the embedded information does not affect the original document information. For such a reason, the B pixel values are modulated to control the variations of the Y ink to be the largest.

The present exemplary embodiment has dealt with only one type of marker mask. However, two or more types of masks may be prepared and embedded in the marker section 1603. For example, two types of masks can be combined to correct a tilt that occurs in scanning the document. More specifically, during the extraction processing, frequency analysis is performed while adjusting angle, and the angle when two types of peaks appear in a predetermined frequency band can be identified as the tilt correction angle.

While the marker mask is described to have the same size as that of the information embedding masks, the sizes may be different. For example, the mask size for the marker section 1603 may be set to twice that for the information section 1602. This enables position search at lower resolution and can reduce the time for identifying the information section 1602.

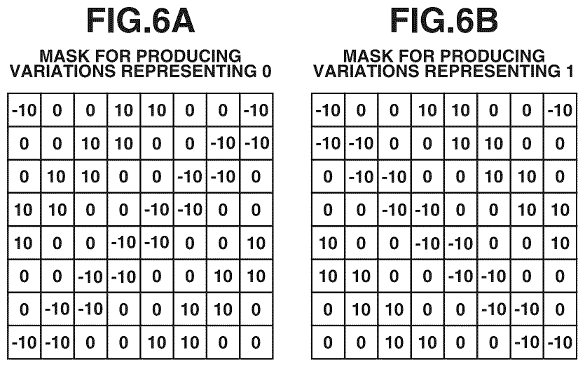

In the present exemplary embodiment, the document has a sufficiently wide paper white section 304, which is the portions of the document 300 other than the text section 301, the rectangle drawing section 302, and the image section 303. Information can fail to be successfully embedded into the information section 1602 using the masks illustrated in FIGS. 4A and 4B, except for the paper white section 304. For example, solid black (R=0, G=0, and B=0) processed using the masks of FIGS. 4A and 4B also results in the same solid black (R=0, G=0, and B=0). To embed information into sections other than the paper white section 304, or into the image section 303 in particular, masks illustrated in FIGS. 6A and 6B are therefore desirably used. An example of the embedding processing on the information section 1602 excluding the marker section 1603 will now be described, whereas the same applies to the marker section 1603.

The masks of FIGS. 6A and 6B apply variations of −10, 0, and +10 to pixel values. In such a case, if the pixel values of the image data in the masked area are all 0, the calculations of the area are −10, 0, and +10, and the resulting pixel values are 0 and +10. In other words, information can be embedded with any pixel values by using the patterns that apply changes to both increase and decrease pixel values.

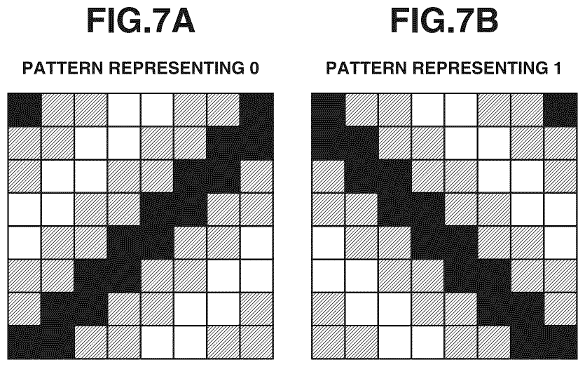

FIGS. 7A and 7B visually illustrate what patterns are applied to the image by the masks for the image section 303. The positions where the masks of FIGS. 6A and 6B are “−10” are illustrated in black, the positions where the masks are “0” are hatched, and the positions where the masks are “10” are illustrated in white. As a result, diagonal lines appear in the image as illustrated in FIGS. 7A and 7B.

As described above, the masks of FIGS. 6A and 6B are suitably used for the image section 303 in FIG. 3. For the text section 301 and the rectangle drawing section 302, which are typically likely to be accompanied by wide paper white sections 304, the masks of FIGS. 4A and 4B are similarly used.

However, the masks of FIGS. 6A and 6B can sometimes be suitable for the text section 301 or the rectangle drawing section 302, depending on the color and character thickness. The image section 303 can include an image extremely similar to the paper white section 304. For more reliable embedding, density histograms of the respective regions are therefore desirably acquired to determine which masks are desirably used, the masks of FIGS. 4A and 4B or the masks of FIGS. 6A and 6B.

In step S205, the host PC 50 generates a print image. The print image may be generated using any conventional technique. In the present exemplary embodiment, an example using the following inkjet-based method will be described.

Four processes, namely, color conversion, ink color separation, output characteristic conversion, and quantization are performed on each pixel of the multiplexed bitmap image composed of RGB pixel values generated in step S204.

The color conversion is a process for converting the RGB information about the multiplexed bitmap image so that the MFP main body 40 can suitably record the image. The reason for the color conversion is that colors described in PDL drawing commands typically have color values that can be suitably expressed on a display, and different colors are output if the values are simply output using a printer.

Specifically, the host PC 50 uses a four-dimensional lookup table to calculate a suitable combination of output pixel values (Rout, Gout, Bout) for a combination of input pixel values (Rin, Gin, Bin). Since the input values Rin, Gin, and Bin have 256 gradation levels each, a table Table1[256][256][256][3] including 256×256×256, i.e., a total of 16,777,216 sets of output values is ideally prepared. The color conversion can be performed by:

Rout=Table1[Rin][Gin][Bin][0],

Gout=Table1[Rin][Gin][Bin][1], and

Bout=Table1[Rin][Gin][Bin][2].

The table size can be reduced using some techniques, for example, by reducing the numbers of grids of the lookup table from 256 grids to 16 grids and determining output values through interpolation of table values at a plurality of grids.

The ink color separation is a process for converting the output values of the color conversion process, Rout, Gout, and Bout, into output values of respective ink colors for inkjet recording. In the present exemplary embodiment, a four-color inkjet printer using C, M, Y, and K inks is assumed. This conversion can be implemented by various methods. In the present exemplary embodiment, a suitable combination of ink color pixel values (C, M, Y, and K) is calculated for a combination of output pixel values (Rout, Gout, and Bout) in a manner similar to the color conversion process. A four-dimensional lookup table Table2[256][256][256][4] is used for that purpose. Specifically, the ink color separation can be performed by:

C=Table2[Rout][Gout][Bout][0],

M=Table2[Rout][Gout][Bout][1],

Y=Table2[Rout][Gout][Bout][2], and

K=Table2[Rout][Gout][Bout][3].

The table size can be reduced using conventional techniques.

Desirable CMYK pixel values corresponding to the pixel values (R=255, G=255, and B=245) obtained by modulating paper white (R=255, G=255, and B=255) using the masks of FIGS. 4A and 4B in step S204 will be described. The Y pixel value is desirably greater than 0. The other CMK pixel values are desirably close to 0 and smaller than the Y pixel value. The reason is that, as described in step S204, the visibility of the embedded image is desirably low.

Next, the output characteristic conversion converts the densities of the respective ink colors into recording dot number ratios. Specifically, for example, the densities in 256 gradation levels per color are converted into dot number ratios Cout, Mout, Yout, and Kout in 1024 gradation levels per color. For that purpose, a two-dimensional lookup table Table3 [4][256] where appropriate recording dot ratios for respective densities of each ink color are set. The output characteristic conversion is achieved by:

Cout=Table3[0][C],

Mout=Table3[1][M],

Yout=Table3[2][Y], and

Kout=Table3[3][K].

The table size can be reduced using some techniques, for example, by reducing the number of grids of the lookup table from 256 grids to 16 grids and determining output values through interpolation of table values at a plurality of grids.

The quantization converts the recording dot number ratios Cout, Mout, Yout, and Kout of the respective ink colors into on/off of recording dots of actual pixels. The quantization can be performed using any method such as error diffusion and dithering. For example, in the case of dithering, the recording dots of the respective ink colors can be turned on/off by comparing the recording dot number ratios with thresholds at each pixel position by:

$$Cdot = Halftone [ Cout ] [ x ] [ y ] ,$$

$$Mdot = Halftone [ Mout ] [ x ] [ y ] ,$$

$$Ydot = Halftone [ Yout ] [ x ] [ y ] , and$$

$$Kdot = Halftone [ Kout ] [ x ] [ y ] .$$

Here, the probabilities of occurrence of recording dots are Cout/1023, Mout/1023, Yout/1023, and Kout/1023.

The generation of the print image in step S205 is thereby completed. The generated print image is transmitted to the inkjet MFP main body 40 and subjected to print processing.

In step S206, the MFP main body 40 prints the print image generated in step S205.

In such a manner, a document obtained by embedding document ID information into document data can be printed on a printing medium. It can be seen from the patterns of FIGS. 5A, 5B, and 5M that the patterns are drawn with 1-pixel diagonal lines. The processing for generating a printout where the document ID information is thus embedded in the image based on the rendered image may be referred to as “multiplexed encoding processing”.

(Perform Multiplexed Embedding with Mixed Gradation Patterns)

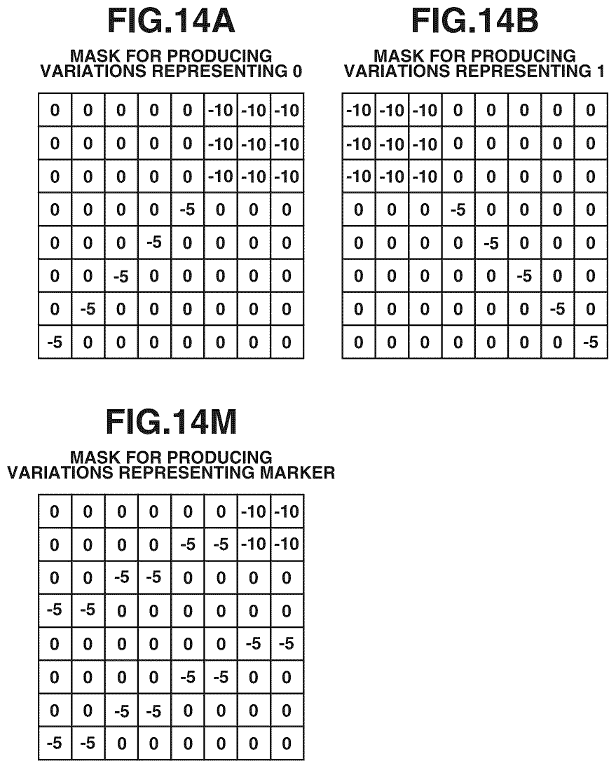

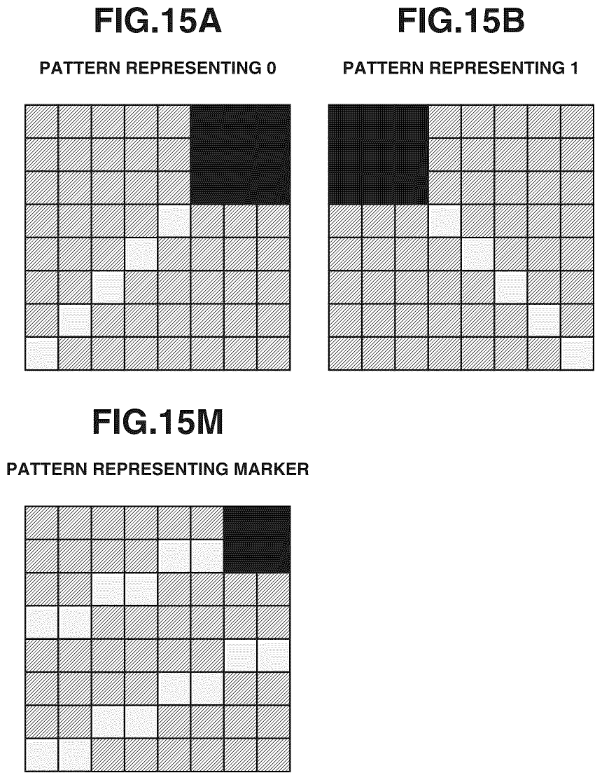

Up to this point, the technique for uniformly thinning the pattern in the marker section compared to the patterns in the information section has been described. However, multiplexing can be performed using mixed gradation patterns. In other words, the density of the print data may be changed differently depending on the areas within the information section. FIGS. 14A, 14B, and 14M are diagrams for describing the mixed gradation patterns. FIGS. 14A, 14B, and 14M illustrate masks corresponding to the pieces of binary embedding information and the marker. The masks are generated with variation values (hereinafter, may be referred to as variation amounts) of “−10” and “−5”. FIGS. 15A, 15B, and 15M illustrate the patterns appearing on the image. The dark portions in the patterns are set to have a low frequency characteristic compared to the light portions. The total variation amounts of the respective masks in the information section and the marker section are made the same, whereby density differences during printing can be reduced to eliminate the need for density adjustment.

When copied documents are read, the dark portions of the patterns are more likely to remain than the light portions of the patterns. The frequency analysis in the extraction processing therefore produces peaks in directional components different from with the embedded masks. This makes the markers difficult to detect, and lowers the identification accuracy of the information section. Even if the markers are detected and the information section is identified, the dark portions are dominant in the patterns and information different from the embedded information is thus detected.

### (Change Embedding Strength Depending on Printing Method)

While the procedure for printing the multiplexed image by inkjet printing has been described so far, there is also a procedure for printing the multiplexed image by electrophotographic printing.

Inkjet printing and electrophotographic printing differ in the color development characteristics of printed documents. Electrophotographic printing develops color better on plain paper than inkjet printing, resulting in higher visibility. If electrophotographic multiplexing is performed at the same embedding strength as with inkjet printing, the multiplexed patterns become noticeable on the printed document. To avoid this, the embedding strength can be uniformly reduced. This, however, results in insufficient pattern formation by inkjet printing and a drop in reading accuracy. In view of this, a method for changing the embedding strength (multiplexing strength) depending on the printing method will now be described.

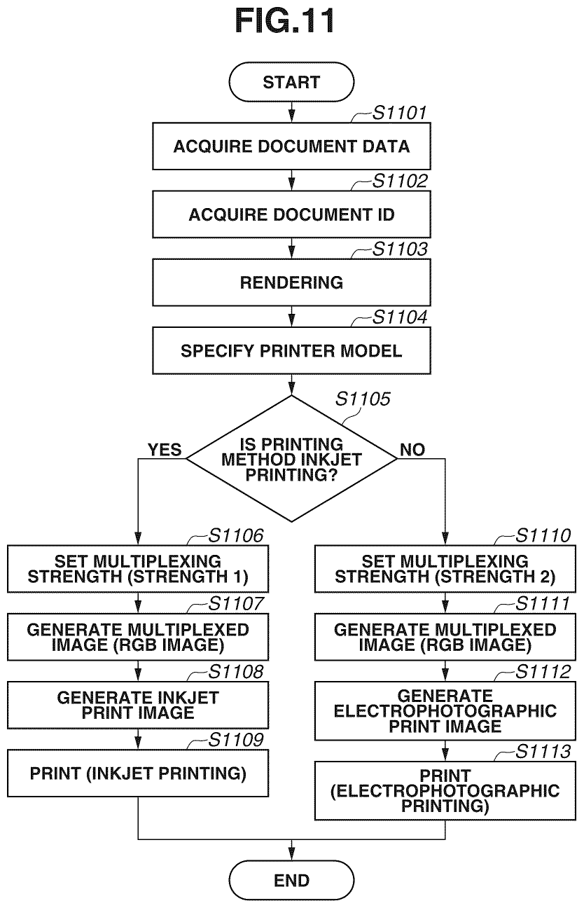

FIG. 11 is a flowchart illustrating processing for changing the embedding strength (multiplexing strength) depending on the printing method. Here, a case where a multiplexed image is printed using the inkjet MFP main body 40 or the electrophotographic MFP main body 60 will be described.

In step S1101, the host PC 50 acquires document data. In the present exemplary embodiment, the host PC 50 connects to an external PC via the network I/F 507, and requests and acquires the document data.

In step S1102, the host PC 50 acquires a document ID that indicates the authenticity of the document data acquired in step S1101. Detailed processing is similar to that of step S202 in FIG. 2A.

In step S1103, the host PC 50 renders the document data acquired in step S1102. In this step, the host PC 50 executes the drawing commands described in the PDL file to form a bitmap image composed of pixel-by-pixel color information.

In step S1104, the host PC 50 specifies the model of the printer (MFP main body) to print the print data on which the document ID is multiplexed. Specifically, the host PC 50 displays a user interface (UI) in response to the user's request for print processing, generates a list of available printer models based on model information obtained by communicating with the printers, and displays the list of printer models on the UI. The user specifies a model to print from the displayed list of printer models. The host PC 50 acquires information indicating the printing method based on the printing device specified by the user. For the sake of description, suppose here that only inkjet and electrophotographic printing devices are connected.

In step S1105, the host PC 50 switches processing depending on whether the printing method is electrophotographic printing or inkjet printing. If the printing method is inkjet printing (YES in step S1105), the processing proceeds to step S1106. If the printing method is electrophotographic printing (NO in step S1105), the processing proceeds to step S1110.

In steps S1106 onward, the procedure for printing a multiplexed image by inkjet printing will be described. In step S1106, the host PC 50 determines the embedding strength of the patterns to be multiplexed by inkjet printing. For the sake of description, the host PC 50 shall change the variation amounts in generating the embedded patterns as the embedding strength.

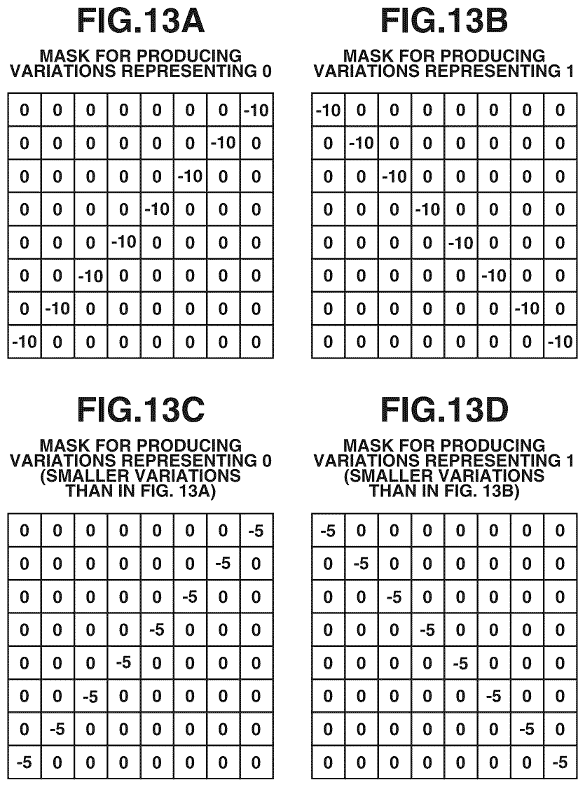

FIGS. 13A to 13D illustrate strength-specific embedding masks to be used during multiplexing. The masks representing “0” and “1” are switched based on the binarized document ID information. The masks of FIGS. 13A and 13B have large variation amounts compared to those of FIGS. 13C and 13D. In other words, the embedding strength in FIGS. 13A and 13B is higher than that in FIGS. 13C and 13D.

The masks (strength 1) of FIGS. 13A and 13B with higher embedding strength are used in inkjet printing. The masks (strength 2) of FIGS. 13C and 13D with lower embedding strength are used in electrophotographic printing. The reason is that electrophotographic printing provides higher visibility than inkjet printing. In step S1106, to obtain the multiplexing strength for inkjet printing, the host PC 50 uses the masks of FIGS. 13A and 13B during the multiplexing processing. Printing density differences between the information section and the marker section can be reduced by making the total variation amounts of the respective masks in the information section and the marker section the same.

In step S1107, the host PC 50 generates a multiplexed image by embedding the acquired document ID information into the bitmap image generated in step S1103 based on the multiplexing strength set in step S1106. The host PC 50 performs the embedding processing on the B plane of the bitmap image with the set multiplexing strength. Detailed embedding processing is similar to that described in step S204 of FIG. 2A, and the set masks (strength 1) are used during embedding.

In step S1108, the host PC 50 generates an inkjet print image from the multiplexed image generated in step S1107. A detailed generation method is similar to the processing described in step S205 of FIG. 2A.

In step S1109, the host PC 50 transmits the inkjet print image generated in step S1108 to the inkjet MFP main body 40 via the data transfer I/F 504 therein, and the MFP main body 40 prints the print image. Here, the data transfer I/F 504 switches the transmission destination of the print image based on the printer model specified in step S1104.

In steps S1110 onward, the procedure for printing a multiplexed image by electrophotographic printing will be described.

In step S1110, the host PC 50 sets the embedding strength of the patterns to be multiplexed by electrophotographic printing. Here, the masks of FIGS. 13C and 13D are used during the multiplexing processing.

In step S1111, the host PC 50 generates a multiplexed image by embedding the acquired document ID information into the bitmap image generated in step S1103 based on the multiplexing strength set in step S1110. The host PC 50 performs the embedding processing on the B plane of the bitmap image with the set multiplexing strength. The set masks (strength 2) are used during embedding.

In step S1112, the host PC 50 generates an electrophotographic print image from the multiplexed image generated in step S1111. The host PC 50 performs processes similar to the color conversion, ink color separation, output characteristic conversion, and quantization described in step S205 of FIG. 2A. The table Table1 for use in the color conversion, the table Table2 for use in the ink color separation, the table Table3 for use in the output characteristic conversion, and the table Halftone for use in the quantization are ones tailored to the MFP main body 60.

In step S1113, the host PC 50 transmits the electrophotographic print image generated in step S1112 to the electrophotographic MFP main body 60 via the data transfer I/F 504 therein, and the MFP main body 60 prints the print image. Here, the data transfer I/F 504 switches the transmission destination of the print image based on the printer model specified in step S1104.

The above is the description of the processing procedure for changing the embedding strength depending on the printing method.

For the sake of description, the multiplexing strength has been described to be changed by adjusting the variation amounts of the masks. However, the multiplexing strength may be changed by switching the number of color planes to embed the document ID information in between inkjet printing and electrophotographic printing.

For example, the embedding strength can be changed by multiplexing the document ID information with only the B plane for electrophotographic printing, and with not only the B plane but also the R plane for inkjet printing. The embedding strength may be changed by increasing relative variation amounts by combining locations where the mask amplitude is reduced and locations where the mask amplitude is increased. In such a case, the relative variation amounts are set to be smaller for electrophotographic printing than for inkjet printing. The embedding strength may be changed by changing the number of locations where the masks vary. In such a case, the number of varying locations is set to be smaller for electrophotographic printing than for inkjet printing.

In the present exemplary embodiment, the B pixel values among the RGB pixel values are described to be modulated. However, the present exemplary embodiment may employ a method for modulating CMYK pixel values. In such a case, paper white is expressed by Y=0, M=0, C=0, and K=0. Modulation values with respect to paper white are therefore desirably positive values. For that purpose, the signs of the modulation values illustrated in FIGS. 4A, 4B, 4M, 6A, and 6B can be inverted, i.e., the modulation values of −10 can be replaced with +10, and the modulation value of +10 can be replaced with −10. The same applies to other numerical values.

Modulating the CMYK pixel values provides higher controllability in limiting the ink to be applied to paper white portions to the Y ink. Modulating the RGB pixel values provides higher controllability in reducing hue variations when embedding information into image sections. It is therefore desirable to select an appropriate modulation method based on the ratios of the paper white, text, and image areas in the document.

If the printing apparatus connected uses a method other than the predetermined methods (in the present exemplary embodiment, neither inkjet printing or electrophotographic printing), the following steps are desirably taken:
Step 1: if there are settings about a correction method dedicated to the printing method, such as modulation strength, use the settings;
Step 2: if there are no such dedicated settings but alternative settings, use the settings; and
Step 3: If there are no dedicated settings or alternative settings, do not perform the multiplexing processing.

For example, in the case of thermal printing using thermosensitive paper that thermally changes in color, the embedding settings for electrophotographic printing are likely to be usable as alternative settings. Similarly, in the case of thermal printing using ink ribbons instead of thermosensitive paper, the embedding settings for electrophotographic printing are also likely to be usable. If neither an inkjet printer nor an electrophotographic printer is connected but a thermal or thermal transfer printer is connected, the same processing as for electrophotographic printing is applied.

A document ID information extraction procedure will be described.

In step S211 of FIG. 2B, the host PC 50 reads a printout where document ID information is multiplexed and encoded.

In step S211, the printed document is set on and read by the scanner unit (hereinafter, may be referred to as a scanner device or a scanner). Specifically, the host PC 50 controls the scanner device to irradiate the document with LED light and convert the reflected light into an analog electrical signal using an image sensor such as a CCD sensor opposed to the pixels.

In step S212, the host PC 50 digitizes the analog electrical signal to acquire digital RGB values. While this bitmap image acquisition processing can use any conventional technique, the present exemplary embodiment describes an example using the following method.

The host PC 50 performs four processes, namely, modulation transfer function (MTF) correction, input correction, shading correction, and color conversion on each pixel of the bitmap image composed of the RGB pixel values acquired in step S211.

The MTF correction corrects the resolution aspect of the scanner's reading performance. Specifically, since the scanning can cause image blurring due to factors such as deviations from the focal position and the performance limitations of the lenses themselves, some degree of restoration is attempted through filter processing. In fact, applying so strong enhancement processing as to fully restore the image can rather make image defects such as overexposure and the exaggeration of image noise and defective pixels noticeable. The filter processing is therefore designed to balance image quality improvement and adverse effects. For ease of description, an example of an edge enhancement filter that multiplies the center pixel value by 5 and the top, bottom, left, and right pixel values by −1 will be described:

$${R}^{′} [ x ] [ y ] = R [ x ] [ y ] \times 5 - R [ x - 1 ] [ y ] - R [ x + 1 ] [ y ] - R [ x ] [ y - 1 ] - R [ x ] [ y + 1 ] ,$$

$${G}^{′} [ x ] [ y ] = G [ x ] [ y ] \times 5 - G [ x - 1 ] [ y ] - G [ x + 1 ] [ y ] - G [ x ] [ y - 1 ] - G [ x ] [ y + 1 ] , and$$

$${B}^{′} [ x ] [ y ] = B [ x ] [ y ] \times 5 - B [ x - 1 ] [ y ] - B [ x + 1 ] [ y ] - B [ x ] [ y - 1 ] - B [ x ] [ y + 1 ] .$$

The input correction is a process for converting the CCD output values, which originally represent photon counts, into brightness levels that match the sensitivity of the human eye. Specifically, for example, R′G′B′ signals of 4096 gradation levels per color are converted into color intensity values R″, G″, and B″ of 1024 gradation levels per color. This conversion can be implemented by using a two-dimensional lookup table Table4[3][4096] where appropriate recording dot number ratios are set for densities of each ink color:

R″=Table4[0][R′],

G″=Table4[1][G′], and

B″=Table4[2][B′].

The table size can be reduced using some techniques, for example, by reducing the number of grids of the lookup table from 4096 grids to 256 grids and determining output values through interpolation of table values at a plurality of grids.

The shading correction is a process for reducing color and density unevenness due to differences in reading sensitivity at respective pixel positions, caused by manufacturing variations and assembly variations of the lenses, LEDs, and CCDs constituting the scanner device. Specifically, for example, the R″G″B″ signals of 1024 gradation levels per color are converted into color intensity values R′″, G′″, and B′″ of 256 gradation levels per color. This conversion can be implemented by using a three-dimensional lookup table Table5[x][3][1024] for density conversion at respective X pixel positions in the direction in which the scanner lenses are arranged (X direction):

$${R}^{′′′} = Table 5 [ x ] [ 0 ] [ {R}^{′′} ] ,$$

$${G}^{′′′} = Table 5 [ x ] [ 1 ] [ {G}^{′′} ] , and$$

$${B}^{′′′} = Table 5 [ x ] [ 2 ] [ {B}^{′′} ] .$$

The table size can be reduced using some techniques, for example, by reducing the number of grids of the lookup table from 1024 grids to 256 grids and determining output values through interpolation of table values at a plurality of grids.

Finally, the host PC 50 performs the color conversion process. This is because, contrary to the case of printing, the R′″, G′″, and B′″ values calculated so far are values specific to the scanner device. The R′″, G′″, and B′″ values are therefore converted into Rout, Gout, and Bout values suitable for display on a display device.

Like the color conversion during printing, the input values R′″, G′″, and B′″ have 256 gradation levels each. A table Table6[256][256][256][3] with 256×256×256, i.e., a total of 16,777,216 sets of output values is thus prepared, and the color conversion is performed by:

Rout=Table1[R′″][G′″][B′″][0],

Gout=Table1[R′″][G′″][B′″][1], and

Bout=Table1[R′″][G′″][B′″][2].

The table size can be reduced using some techniques, for example, by reducing the numbers of grids of the lookup table from 256 grids to 16 grids and determining output values through interpolation of table values at a plurality of grids.

By such a procedure, the acquisition of the bitmap image in step S212 is completed. When the bitmap image is acquired from a copied document through this series of processes, the marker section becomes thinner that the other areas due to degradation during copying in addition to the original multiplication processing control.

In step S213, the host PC 50 extracts the multiplexed document ID information.

As an extraction method, the host PC 50 determines whether the marker pattern of FIG. 5M is recorded, identifies the marker section, and divides the image into blocks in units of 8×8 pixels based on the marker section. The host PC 50 determines which of the patterns of FIGS. 5A and 5B is recorded, and extracts information 0 or 1. Such an operation is repeated to decode the multiplexed information.

The decoding of the multiplexed information will be outlined.

The host PC 50 detects the position where the multiplexed information is embedded in the acquired bitmap image. Specifically, the host PC 50 detects the embedded position by analyzing the spatial frequency characteristics of the 8×8-pixel regions in the bitmap image.

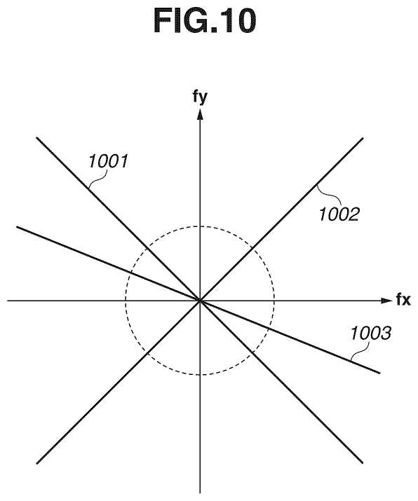

FIG. 10 is a diagram illustrating the spatial frequency characteristics of the patterns used for embedding. The horizontal axis indicates the horizontal frequency, and the vertical axis indicates the vertical frequency. The farther from the origin, the higher the frequency band. In the exemplary embodiment, as illustrated in FIGS. 4A, 4B, and 4M, three patterns are embedded in the image. In the embedding example, values of 10 are subtracted from the B component of the RGB image. The pattern of FIG. 4A thereby produces a high power spectrum along a line 1001. Similarly, the pattern of FIG. 4B produces a high power spectrum along a line 1002. Moreover, values of 5 are subtracted from the B plane of the RGB image. The pattern of FIG. 4M thereby produces a high power spectrum along a line 1003.

By detecting these power spectra, the host PC 50 detects the marker section, then identifies the information section, and extracts embedded data “0” and “1”. As preprocessing of the detection, the host PC 50 can perform edge detection to enhance the power spectra.

For data extraction through the frequency analysis, precise cropping of the analysis areas from the image data is desirable. Processing for correcting deviations in the coordinate positions is thus performed. For example, there is a method for vertically and horizontally repeating the cropping of an 8×8-pixel area from the bitmap image and the frequency analysis of the 8×8-pixel area while shifting the position by one pixel. After repetitions of 8 pixels in the horizontal direction and 8 pixels in the vertical direction, i.e., a total of 64 times, the location where the spectrum is the highest is employed as the reference position for cropping the marker section. This enables accurate detection of the marker section, based on which the multiplexed information in the information section can be extracted to obtain the embedded sequence of numbers 0's and 1's.

In the present exemplary embodiment, as described in step S204, the multiplexing information to be embedded is text document data that is numerically converted in advance using the character code “Shift JIS”.

As described above, in Shift JIS single-byte code (half-width characters), “h” corresponds to binary data “01101000”, “e” to “01100101”, “1” to 01101100”, and “o” to “01101111.

If the numerical sequence of the extracted additional information is “0110100001100101011011000110110001101111”, it corresponds to the character string “hello”.

In fact, the host PC 50 extracts the document ID information embedded in step S204 as additional information, and the processing ends.

In the case of embedded information to which the processing of the present exemplary embodiment is applied, the extraction of the embedded information from an ordinarily copied document is highly likely to fail.

In step S214, the host PC 50 determines whether the document ID information is successfully extracted.

If the determination is YES (YES in step S214), the processing proceeds to step S215. If the determination is NO (NO in step S214), the processing proceeds to step S220 to generate print data based on the scanned image.

There are two possible cases where the determination is NO:
Case 1: The document ID information is not embedded in the document scanned in step S211 in the first place.
Case 2: The document ID information is embedded, but the embedded data is not successfully read due to stains on the printout or because a significant amount of information is manually added afterward.

In case 1, the processing may simply proceed to step S220. In case 2, the host PC 50 may notify the user that “the user is attempting to copy an authentic document with an embedded document ID”. This informs the user that he/she is attempting to generate an “inauthentic copy” as a “copy of an authentic document”. This can give the user an opportunity to select whether to quit copying. In the present exemplary embodiment, the determination of case 2 can be made when one or more bits and not more than 31 bits of 32-bit document ID information are extracted in step S213. Considering the possibility that there happens to be one similar pattern in the image, the determination is desirably made when at least one half, or 16 bits, or more and not more than 31 bits are extracted.

In step S215, the host PC 50 collates the document ID information extracted in step S215.

Like step S202, the host PC 50 issues a collation request to the external PC via the network I/F 507 to check whether the document ID information extracted is authentic. Here, the tampering risk of the document ID itself can be reduced by a plurality of PCs constituting a blockchain for managing document data and document ID information.

In step S216, the host PC 50 determines whether the document ID is valid as a result of the collation of the document ID information. If the determination is YES (YES in step S216), the processing proceeds to step S217. If the determination is NO (NO in step S216), the processing proceeds to step S220 to generate print data based on the scanned image.

If the determination of step S216 is NO, the host PC 50 may notify the user that “the user is attempting to copy an inauthentic document with an invalid document ID”. This can give the user an opportunity to select whether to quit copying.

In step S217, the host PC 50 performs a tampering check on the document. To perform the tampering check, the host PC 50 acquires the document data based on the document ID information from an external PC via the network I/F 507. The host PC 50 then renders the document data as in step S203. The host PC 50 compares the rendering result with the scanning result, and determines the presence or absence of tampering.

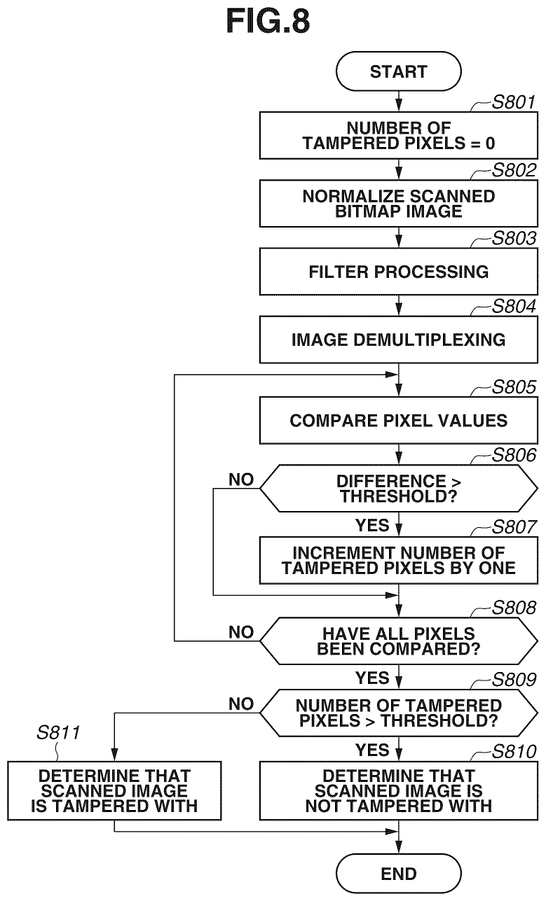

FIG. 8 illustrates a document tampering presence/absence determination procedure.

In step S801, the host PC 50 performs initialization and sets the number of tampered pixels=0.

In step S802, the host PC 50 normalizes the scanned bitmap image. The reason is that the dynamic range of the bitmap image differs from that of the rendered image, and the two images are difficult to simply compare.

For example, the brightest parts of the bitmap image are typically the color of the document paper, and in principle have some density value. By contrast, the brightest parts of the rendered image are pixels of R=255, G=255, and B=255. There is therefore an inherent difference in the brightest colors of the two images.

Similarly, the darkest parts of the bitmap image are typically the color of black ink or toner, and in principle have some brightness value due to reflected light. By contrast, the darkest parts of the rendered image are pixels of R=0, G=0, and B=0. There is therefore an inherent difference in the darkest colors of the two images.

For the color tones of a color document, the most vivid red that can be printed on the document has a low saturation compared to the most vivid red (R=255, G=0, B=0) in the rendered image.

The pixel values R, G, and B of the bitmap image can thus be normalized by:

$$Rnorm = ( R - Rd ) / ( Rw - Rd ) \times 255 ,$$

$$Gnorm = ( G - Gd ) / ( Gw - Gd ) \times 255 , and$$

$$Bnorm = ( B - Bd ) / ( Bw - Bd ) \times 25 \; 5 .$$

This can make the brightest color of the bitmap image into R=255, G=255, and B=255, and the darkest color of the bitmap image into R=0, G=0, and B=0.

In step S803, the host PC 50 performs filter processing. The reason is that while the foregoing MTF correction enhances edges within a visually desirable range, filter processing for stronger edge enhancement is desirable for the sake of image comparison.

In step S804, the host PC 50 performs image demultiplexing. The purpose is to remove as much differences between the original document data to be restored and the printed document that occur due to the generation of the multiplexed image in step S203 of FIG. 2A as possible. Specifically, since the data embedded in the image data has been successfully extracted from the read multiplexed data, the embedded data can be conversely subtracted to bring the read image data close to the document data before the embedding. In the present exemplary embodiment, this removal is implemented by further embedding values obtained by multiplying the mask values for embedding 0 and 1 illustrated in FIGS. 4A and 4B or FIGS. 6A and 6B by −1 into the read image.

In step S805, the host PC 50 compares the images. In the present exemplary embodiment, image A obtained by rendering the document data in step S217 and demultiplexed image B corrected in step S503 are compared pixel by pixel:

ΔR=|R[X][Y] of image A−R[X][Y] of image B|,

ΔG=|G[X][Y] of image A−G[X][Y] of image B|, and

ΔB=|B[X][Y] of image A−B[X][Y] of image B|.

In step S806, the host PC 50 determines whether the differences in the pixel values exceed a threshold. In the present exemplary embodiment, thresholds Rth, Gth, and Bth are provided for the R, G, and B channels, respectively, and the determination is made as follows:

If ((ΔR > Rth) ||
(ΔG > Gth) ||
(ΔB > Bth)) {“YES”}
Else {“NO”}

In the present exemplary embodiment, Rth=Gth=Bth=64, whereas the thresholds are desirably set as appropriate depending on the characteristics of the reading device and the recording device.

If the determination is NO (NO in step S806), the processing proceeds to step S808. If the determination is YES (YES in step S806), the processing proceeds to step S807.

In step S807, the host PC 50 increments the number of tampered pixels by 1. The processing proceeds to step S808.

In step S808, the host PC 50 determines whether all the pixels have been compared.

If the determination is NO (NO in step S808), the processing proceeds to step S805 to continue comparison. If the determination is YES (YES in step S808), the processing proceeds to step S809.

In step S809, the host PC 50 determines whether the number of tampered pixels exceeds a threshold. If the determination is YES (YES in step S809), the processing proceeds to step S810. In step S810, the host PC 50 determines that the scanned image is not tampered with. The processing proceeds to step S218.

If the determination of step S809 is NO (NO in step S809), the processing proceeds to step S811. In step S811, the host PC 50 determines that the scanned image is tampered with. The processing proceeds to step S218.

In the present exemplary embodiment, the threshold for the number of tampered pixels is 3% of the total number of pixels, considering cases where dust is present in the scanned image. The threshold can be set as appropriate depending on the characteristics of the printing and reading devices.

In step S218, the host PC 50 determines whether the scanned image is tampered with. If the determination is YES (YES in step S218), the processing proceeds to step S219. If the determination is NO (NO in step S218), the processing proceeds to step S220 to generate print data based on the scanned image.

If the determination of step S218 is YES, the host PC 50 may notify the user that “the user is attempting to copy a tampered authentic document”. This can give the user an opportunity to select whether to quit copying.

### <Superpose Extracted Document ID on Original Document Data>

In step S219, the host PC 50 adds information indicating duplication (information indicating authenticity) to the image. The information indicating authenticity is added in the following manner. Like step S217, the host PC 50 acquires the document data based on the document ID information. Like step S203, the host PC 50 renders the acquired document data. Like step S204, the host PC 50 performs the multiplexing processing on the rendered document image, thereby forming a multiplexed image. The document ID extracted in step S213 is used as the document ID information to be embedded here. In such a manner, the host PC 50 adds the information indicating authenticity to the image.

If the document data is not available, the scanned image may be used instead.

### <Reduce Embedded Patterns in Scanned Image and Superpose New Embedded Patterns>

The embedded patterns in the scanned image may be reduced and the multiplexing processing may be performed again. As a method for reducing the embedded patterns, the host PC 50 applies a smoothing filter of predetermined size to the scanned image. The filter size may be set based on the size of the embedded patterns (here, 8×8 pixels). An inverse filter calculated from the embedded patterns may be used.

If a pattern-embedded area is a blank area, the host PC 50 may change the pixel values into those of paper white through background removal. If the embedded patterns are applied to a specific color plane, such reduction processing may be performed on only the specific color.

To use a common process for documents printed by inkjet printing and electrophotographic printing in reducing the embedded patterns in the scanned images, the embedding strengths of both printing methods on paper are desirably the same. The embedding strength is therefore desirably changed depending on the printing method.

For the image where the embedded patterns are reduced, the host PC 50 performs the multiplexing processing for embedding the extracted document ID like step S204.

In step S220, the host PC 50 generates a print image. In step S221, the host PC 50 prints the print image. Since specific processing is similar to that of steps S205 and S206, a description thereof will be omitted.

In step S222, the host PC 50 displays a UI. The authenticity of the document and the absence of tampering are displayed on the UI. If the authenticity of the document and the absence of tampering are unable to be determined through the foregoing procedure, the UI is not displayed. This enables the user to find out if the authenticity of the document is not confirmed or the document is tampered with. For example, if the document ID information is not successfully extracted and the determination of step S214 is NO, the host PC 50 does not display the UI indicating the authenticity of the document and the absence of tampering. Other examples where the UI is also hidden include when the document ID is not determined to be valid as a result of the collation of the document ID and the determination of step S216 is NO, and when tampering is not determined to be absent and the determination of step S218 is NO.

While the UI is described to be displayed when the document is authentic and not tampered with, a UI may be displayed for user notification when the document is inauthentic or tampered with.

According to the present exemplary embodiment, the patterns in the marker section are made thin. The patterns embedded in the marker section degrade due to deterioration during copying, which lowers the accuracy of position identification of the information section and makes accurate extraction difficult. As a result, the risk of the embedded information being extracted from the copy can be reduced.

A modification of the first exemplary embodiment will be described. In the first exemplary embodiment and FIGS. 4A, 4B, 4M, 6A, and 6B, information is described to be embedded in units of 8×8 pixels.

This is an example where embedding is performed in a manner less visible to the user by embedding information in high-frequency domains. However, the effects of the present exemplary embodiment can be obtained not only by the multiplexing with the high-frequency domains but by any multiplexing method.

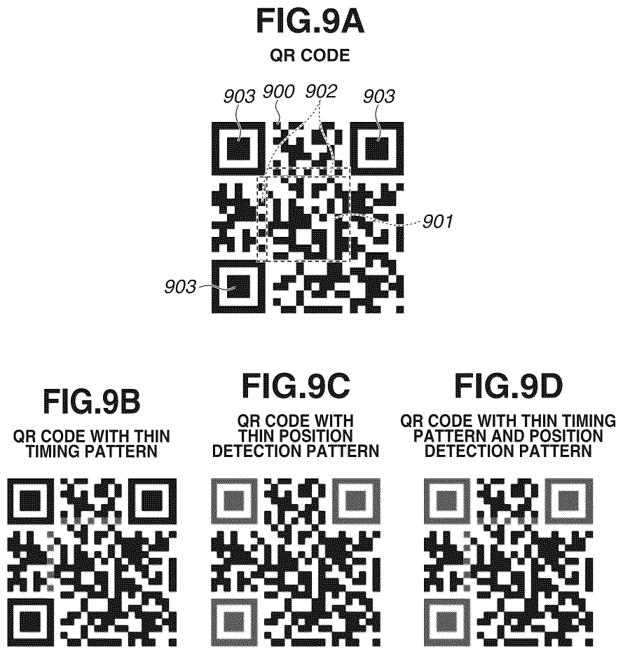

As another example, a method for embedding a document ID using a QR code (registered trademark) will be described. FIG. 9A illustrates the configuration of a QR code. An entire QR code 900 includes an information section 901 where information is embedded, a timing pattern (marker section) 902, and a position detection pattern 903. In other words, the information section 901 and the marker section 902 are included in the QR code as a part of the QR code. In extracting information from the QR code 900, the position detection pattern 903 is detected for position identification, and then the timing pattern 902 is searched for. The area within the information section 901 is divided into blocks based on the detected timing, and information is extracted from the blocks.

A method for thinning the marker section in the case of using a QR code will be described. The density of the black dots in the timing pattern 902 is made lower than that of the black dots in the information section 901. Here, the density of the black dots in the timing pattern 902 is set to one half that of the black dots in the information section 901.

FIG. 9B is a diagram illustrating the result of the foregoing processing. When the document on which the QR code is printed is copied to extract information, the timing pattern 902 degrades due to the copying. This lowers the accuracy of block division during extraction and can reduce the risk of the embedded information being extracted.

As illustrated in FIG. 9C, the position detection pattern 903 of the QR code, which plays a similar role to that of the markers, may be thinned. Degradation of the position detection pattern 903 during copying lowers the accuracy of position detection and can reduce the risk of the embedded information being extracted.

As illustrated in FIG. 9D, the timing pattern 902 and the position detection pattern 903 of the QR code may be thinned. Degradation of the accuracy of both position detection and block division during copying can further reduce the risk of the embedded information being extracted. Such settings may be switched depending on the importance of the printout. For example, only the timing pattern 902 is thinned by default. Only the position detection pattern 903 is thinned for higher importance, and both the patterns 902 and 903 are thinned for even higher importance.

The density of the black dots in the timing pattern 902 and the position detection pattern 903 is made lower than that of the black dots in the information section 901. Here, the density of the black dots in the patterns 902 and 903 is set to one half that of the black dots in the information section 901. When the document on which the QR code is printed is copied to extract information, the position detection pattern 903 and the timing pattern 902 thus degrade due to the copying. This can lower the accuracy of position detection and reduce the risk of the embedded information being extracted.

As another example of multiplexing, there is a method of performing multiplexing through threshold modulation during the quantization process in the print image generation processing of step S205 in FIG. 2A (Japanese Patent No. 2187749). Such a technique may be employed.

In the first exemplary embodiment, the density of the marker section is described to be lowered by switching the patterns between the marker section and the information section. However, depending on the printing method, the accuracy of position detection from the markers can be lowered during copying by multiplexing the marker section with a specific ink color. In view of this, a second exemplary embodiment will describe a method for changing the color plane to embed the markers in depending on the printing method.

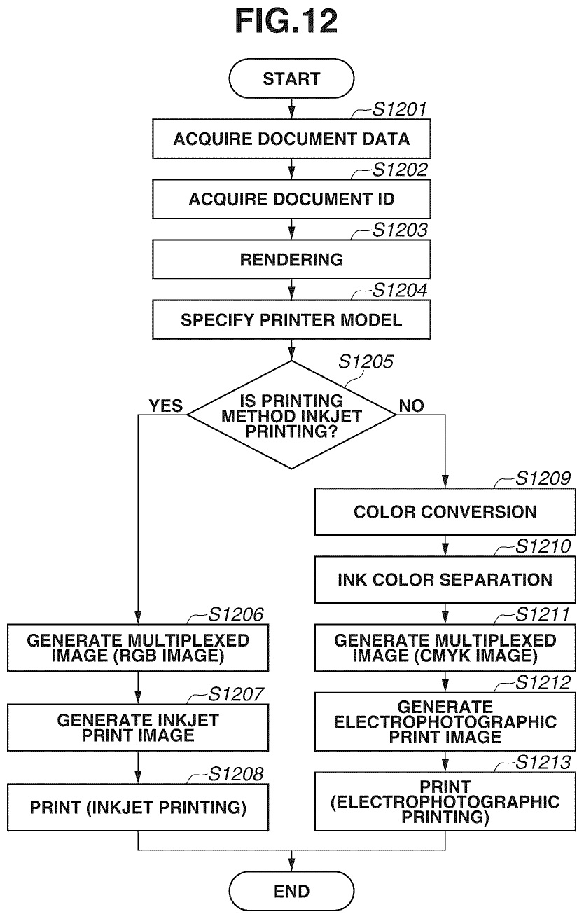

FIG. 12 is a flowchart for describing processing for changing the color plane of an image to multiplex the markers with depending on the printing method. Here, a case where the image is printed using an inkjet MFP main body 40 or an electrophotographic MFP main body 60 will be described.

The processing of steps S1201 to S1204 is similar to that of steps S1101 to S1104 in FIG. 11. A description thereof will thus be omitted.

In step S1205, a host PC 50 switches the subsequent processing based on whether the printing method acquired in step S1204 is electrophotographic printing or inkjet printing. If the printing method is inkjet printing (YES in step S1205), the processing proceeds to step S1206. If the printing method is electrophotographic printing (NO in step S1205), the processing proceeds to step S1209.

The processing of steps S1206 onward deals with the procedure for printing a multiplexed image by inkjet printing. In step S1206, the host PC 50 generates the multiplexed image by embedding the document ID information acquired in step S1202 into the bitmap image rendered in step S1203. The rendered bitmap image is expressed in an RGB space, and the marker section is embedded in the B plane. The information section is embedded in the R plane. Detailed embedding processing is similar to the processing described in step S204 of FIG. 2A.

In step S1207, the host PC 50 generates an inkjet print image from the multiplexed image generated in step S1206. A detailed generation method is similar to the processing described in step S205 of FIG. 2A.

In step S1208, the host PC 50 transmits the inkjet print image generated in step S1207 to the inkjet MFP main body 40 via a data transfer I/F 504 therein, and the MFP main body 40 prints the print image. Here, the data transfer I/F 504 switches the transmission destination of the print image based on the printer model specified in step S1204.

The processing of steps S1209 onward deals with the procedure for printing a multiplexed image by electrophotographic printing. In step S1209, the host PC 50 performs color conversion on the bitmap image generated in step S1203. The color conversion is a process for converting the RGB information about the bitmap image so that the MFP main body 60 can suitably print the image. A detailed conversion method is similar to the processing of the color conversion described in step S205 of FIG. 2A. The color conversion is performed using the table Table1 tailored to the MFP main body 60.

In step S1210, the host PC 50 performs ink color separation on the color-converted image generated in step S1209 into as many ink colors as used in the MFP main body 60. Here, the color-converted image is separated into four colors, namely, cyan, magenta, yellow, and black. In the present exemplary embodiment, the MFP main body 60 is assumed to be a four-color electrophotographic printer using cyan, magenta, yellow, and black toners. Detailed processing of the ink color separation is similar to the processing of the ink color separation described in step S205 of FIG. 2A. The ink color separation is performed using the table Table2 tailored to the MFP main body 60.

In step S1211, the host PC 50 generates a multiplexed image by embedding the document ID information acquired in step S1202 into the ink color-separated image generated in step S1210. Here, the host PC 50 embeds the marker section into the Y plane obtained by the ink color separation, and embeds the information section into the K plane. Since the acquired document ID information is stored as binary data, the embedding masks are switched based on the bit information. The two masks of FIGS. 4A and 4B are used for the information section. The mask of FIG. 4M is used for the marker section. In the information section, the document ID information is superposed on the image by switching the masks based on the bit information of the document ID information and changing the target pixel values of the K plane based on the modulation within the masks. In the marker section, the markers are superposed on the image by changing the target pixel values of the Y plane based on the modulation within the mask. While the markers are described to be multiplexed with the Y plane, the markers may be multiplexed with other than the Y plane if the image area to be multiplexed also uses toners other than the Y toner.

In step S1212, the host PC 50 generates an electrophotographic print image from the multiplexed image generated in step S1211. The host PC 50 performs processes similar to the output characteristic conversion and the quantization described in step S205 of FIG. 2A. The table Table3 for use in the output characteristic conversion and the table Halftone for use in the quantization are ones tailored to the MFP main body 60.

In step S1213, the host PC 50 transmits the electrophotographic print image generated in step S1212 to the electrophotographic MFP main body 60 via the data transfer I/F 504 therein, and the MFP main body 60 prints the print image. Here, the data transfer I/F 504 switches the transmission destination of the print image based on the printer model specified in step S1204.

The above is the description of the processing procedure for changing the color plane of the image to be multiplexed depending on the printing method.

Effects of the present exemplary embodiment will be described. In inkjet printing, the markers for identifying the embedded information area are embedded in the B plane. In electrophotographic printing, the markers are embedded in the Y plane. The markers can thereby be embedded in an inconspicuous manner in each printing method.

Furthermore, the following effects can be obtained. In inkjet printing, the types of inks installed vary widely, like dark inks, light inks, and special color inks, depending on the printer model. Some gradation levels are expressed using either one or both of dark and light inks. If the multiplexing is performed on only a specific plane, such as a dark ink color plane, there may be cases where dots are not discharged depending on the gradation level. As a result, the multiplexed pattern is unable to be formed, and the extraction accuracy can drop. On the other hand, electrophotographic printing has high visibility compared to inkjet printing since the toners do not bleed on paper. Patterns embedded in highly visible ink color other than yellow can thus be conspicuous. In the present exemplary embodiment, the plane to be multiplexed is changed depending on the printing method. This can accommodate the foregoing multiple ink colors in inkjet printing and reduce image quality degradation caused by the multiplexing in the electrophotographic printing.

A third exemplary embodiment describes a method for switching between secure embedding using a technique that reduces the risk of embedded information being extracted during document copying and normal embedding not taking into account the measures during copying. In the present exemplary embodiment, the embedding method is switched based on user instructions.

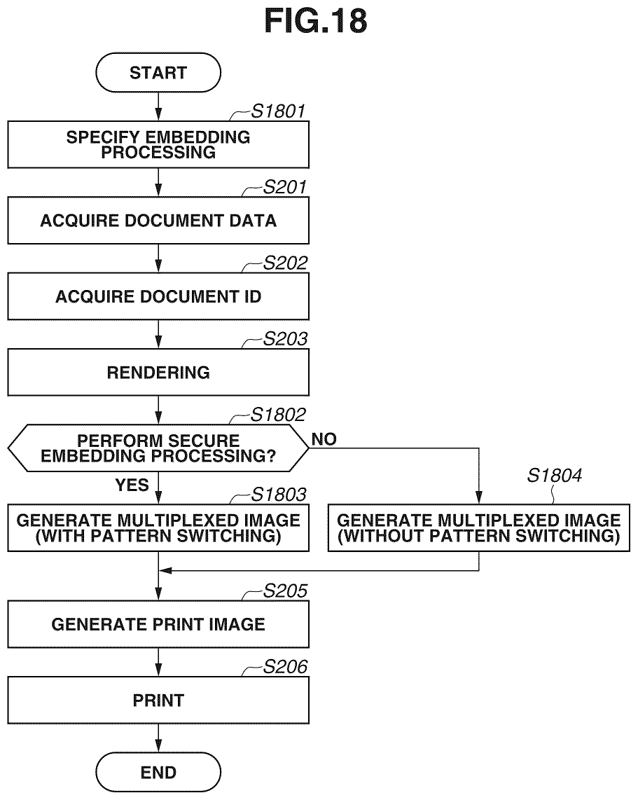

FIG. 18 is a flowchart for describing the switching between the secure embedding processing and the normal embedding processing based on user instructions. Processes with the same step numbers as in FIG. 2A are similar processes. A description thereof will thus be omitted.

In step S1801, the embedding processing to be performed is specified based on user instructions. A host PC 50 displays options for the secure embedding processing and the normal embedding processing on a UI displayed on a display device (not illustrated), and has the user select in which mode to perform the embedding processing using HIDs such as a keyboard and a mouse.

In step S1802, the host PC 50 switches the processing based on the setting made by the user in step S1801.

If the secure embedding processing is performed (YES in step S1802), the processing proceeds to step S1803. If the secure embedding processing is not performed (NO in step S1802), the processing proceeds to step S1804.

Step S1803 represents a procedure for performing the secure embedding processing. In step S1803, the host PC 50 performs embedding processing where patterns of different density variations are switched between the information section and the marker section. The actual processing is similar to that of step S204 in FIG. 2A. A description thereof will thus be omitted here. Once the generation of the multiplexed image is completed, the processing proceeds to step S205.

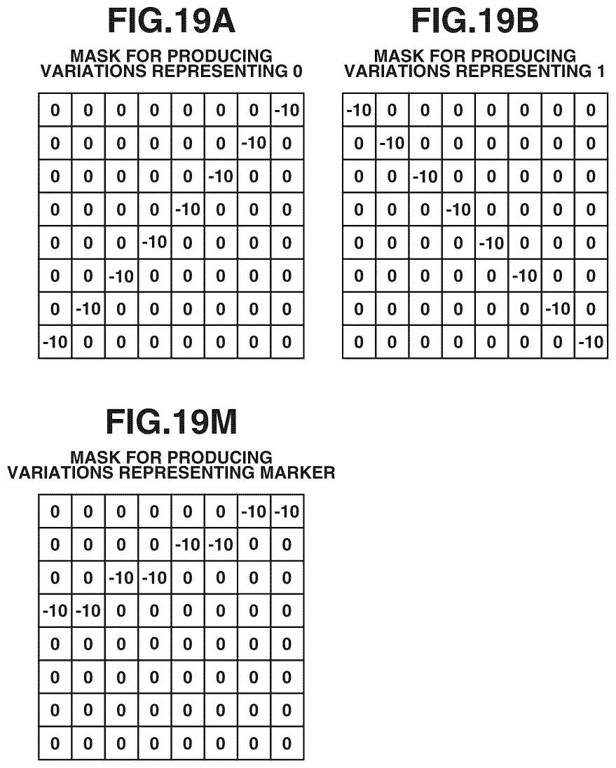

Step S1804 represents a procedure for performing the normal embedding processing, not the secure embedding processing. In step S1804, the host PC 50 performs embedding processing using patterns of the same density variations for the information section and the marker section. FIGS. 19A and 19B illustrate two masks for superposing information on the image. FIG. 19M illustrates a mask for superposing markers. The masks of FIGS. 19A and 19B are used to embed information. The mask of FIG. 19M is used to embed markers for identifying the position of the information section during extraction. The marker-specific mask of FIG. 19M is set to a density equivalent to that of the information section-specific masks of FIGS. 19A and 19B.

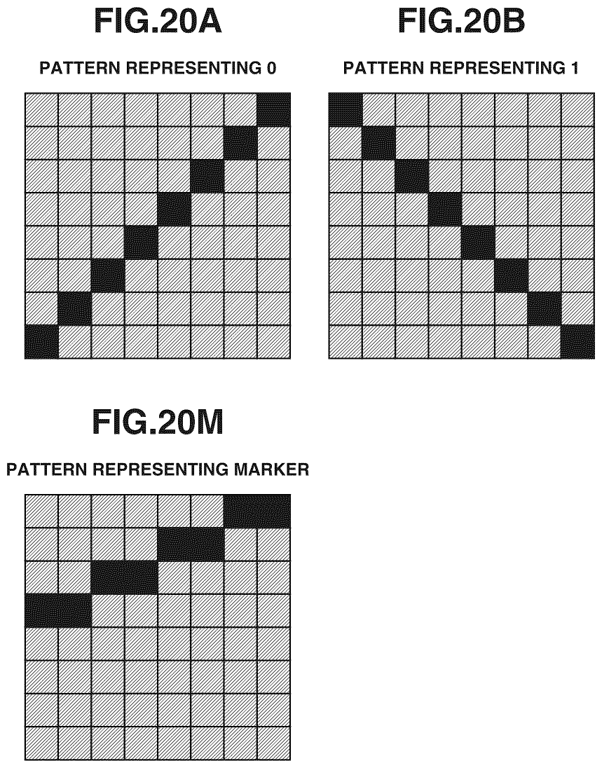

FIGS. 20A, 20B, and 20M visually illustrate what patterns are applied to the image by the masks of FIGS. 19A, 19B, and 19M. The positions corresponding to “−10” in the masks of FIGS. 19A and 19B are illustrated in black, and the positions corresponding to “0” are hatched. Diagonal lines as illustrated in FIGS. 20A and 20B appear on the image. The subsequent embedding processing is similar to the processing of step S204 in FIG. 2A. A description thereof will thus be omitted. Once the generation of the multiplexed image is completed, the processing proceeds to step S205.

The processing of steps S205 onward is similar to that in FIG. 2A. A description thereof will thus be omitted.

The above is the description of the processing procedure for switching between the secure embedding processing and the normal embedding processing based on user settings.

As described above, if the secure embedding processing is set by the user, the embedding patterns of different densities are used for the information section and the marker section. This enables the marker section to degrade during copying and reduce the extraction accuracy of the information section. If the normal embedding processing is set, the embedding patterns of equivalent densities are used for the information section and the marker section without an intentional deterioration in the extraction accuracy.

By changing the combination of masks used for the embedding processing based on the user-specified condition, the embedding processing with a reduced risk of the embedded information being extracted from a copied printout can be performed if the secure embedding processing is specified.

The embedding processing is performed so that density differences of the information section and the marker section are substantially the same in RGB or CMYK. This enables the extraction of the embedded information from a Y channel obtained by YCC conversion of the scanned image for improved accuracy. In addition, the present processing can be applied to even monochrome printers. With improved decoding accuracy, slight degradation of the marker section during copying can prevent the marker section from being identified. This can further reduce the extraction accuracy, enabling the development of the effect.

Exemplary embodiments of the present disclosure can also be implemented by processing for supplying a program for implementing one or more functions of the foregoing exemplary embodiment to a system or an apparatus via a network or a storage medium, and reading executing the program by one or more processors in a computer of the system or apparatus. A circuit that implements one or more of the functions (such as an application specific integrated circuit [ASIC]) can also be used for implementation.

According to exemplary embodiments of the present disclosure, when a multiplexed document is copied, the extraction of additional information from the copied document can be prevented.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019858, filed Feb. 13, 2024, which is hereby incorporated by reference herein in its entirety.

What is claimed is:

1. An image processing apparatus comprising:
a print data acquisition unit configured to acquire print data to be printed on a printing medium; and
a generation unit configured to generate multiplexed data by multiplexing a first predetermined pattern with a printing area where the print data is printed among areas of the printing medium and multiplexing a second predetermined pattern with a marker area different from the printing area among the areas of the printing medium,
wherein the multiplexed second predetermined pattern has a density lower than that of the multiplexed first predetermined pattern on the printing medium.

2. The image processing apparatus according to claim 1, wherein the first predetermined pattern is a pattern configured to change density of the print data.

3. The image processing apparatus according to claim 1, wherein the first predetermined pattern is configured to change density of the print data differently depending on a type of the printing medium or a print mode.

4. The image processing apparatus according to claim 1, wherein density of the print data due to the second predetermined pattern is lower than or equal to one half that of the print data due to the first predetermined pattern.

5. The image processing apparatus according to claim 1, wherein the first predetermined pattern is a pattern configured to apply changes to increase and decrease pixel values of the print data.

6. The image processing apparatus according to claim 1, wherein the first predetermined pattern is configured to change density of the print data differently depending on the areas on the printing medium.

7. The image processing apparatus according to claim 1, wherein the second predetermined pattern is set to surround the first predetermined pattern.

8. The image processing apparatus according to claim 1, wherein the first and second predetermined patterns are a part of a Quick Response (QR) code.

9. The image processing apparatus according to claim 1, wherein the second predetermined pattern is multiplexed with a specific colorant color.

10. The image processing apparatus according to claim 9, wherein the specific colorant color is yellow.

11. The image processing apparatus according to claim 9, further comprising an acquisition unit configured to acquire printing device information indicating a printing method for printing the multiplexed data,
wherein a multiplexing strength of the multiplexed data and the specific colorant color vary depending on the printing device information.

12. The image processing apparatus according to claim 11, wherein if the printing method is inkjet printing, the specific colorant color is blue, and if the printing method is electrophotographic printing, the specific colorant color is yellow.

13. The image processing apparatus according to claim 12, wherein the multiplexing strength of the multiplexed data is lower for electrophotographic printing than for inkjet printing.

14. The image processing apparatus according to claim 1, wherein the second predetermined pattern includes more locations where density of the print data varies within the pattern than does the first predetermined pattern.

15. The image processing apparatus according to claim 14, wherein the second predetermined pattern includes two types of density variation amounts of the print data within the pattern, and the second predetermined pattern multiplexed with the marker area includes the greater of the variation amounts as a low-frequency component and the lesser of the variation amounts as a high-frequency component.

16. The image processing apparatus according to claim 1, wherein the second predetermined pattern has a pattern size greater than the printing area.

17. The image processing apparatus according to claim 1, wherein information multiplexed by the first predetermined pattern is information indicating authenticity of the print data.

18. An image processing method comprising:
acquiring print data to be printed on a printing medium; and
generating multiplexed data by multiplexing a first predetermined pattern with a printing area where the print data is printed among areas of the printing medium and multiplexing a second predetermined pattern with a marker area different from the printing area among the areas of the printing medium,
wherein the multiplexed second predetermined pattern has a density lower than that of the multiplexed first predetermined pattern on the printing medium.

19. A non-transitory computer-readable storage medium storing instructions that, when executed by a computer, cause the computer to perform a method comprising:
acquiring print data to be printed on a printing medium; and
generating multiplexed data by multiplexing a first predetermined pattern with a printing area where the print data is printed among areas of the printing medium and multiplexing a second predetermined pattern with a marker area different from the printing area among the areas of the printing medium,
wherein the multiplexed second predetermined pattern has a density lower than that of the multiplexed first predetermined pattern on the printing medium.
